(19) United States
(12) Patent Application Publication
(10) Pub. No.: US 2007/0013662 A1
(43) Pub. Date: Jan. 18, 2007

(54) Multi-configurable tactile touch-screen keyboard and associated methods

(76) Inventor: Richard Mark Fauth, Greeley, CO (US)

Correspondence Address: MORRISON & FOERSTER LLP, 755 PAGE MILL RD, PALO ALTO, CA, 94304-1018, US

(21) Appl. No.: 11/181,441

(22) Filed: Jul. 13, 2005

(51) Int. Cl. G09G 5/00

(52) U.S. Cl. 345/168

(57) ABSTRACT

An input device for use with computer systems is provided. In one example, an input device includes a touch-sensitive screen and an overlay positioned over the touch-sensitive screen, the overlay having a plurality of tactile features. The touch-sensitive screen is operable to display one or more images, e.g., of multiple keyboard configurations, character sets, or other control functions, to facilitate input to a computer system. The image may be varied to provide a multi-configurable input device. Additionally, the tactile features may include transparent extruded areas, such as ridges, molded key features, indentations, protrusions or the like arranged to provide users with a tactile feel (e.g., for motion and/or location) of varying portions of the underlying displayed image.

### FIELD

The invention relates generally to computer keyboard devices and display systems, and in one aspect to computer keyboard devices that may adapt to multiple configurations, e.g., for use with two or more keyboard configurations such as QWERTY or AZERTY configurations.

### BACKGROUND

Computer systems running Windows™ XP, Macintosh™, Linux™, or other similar operating systems may include the ability to change the language in which information is displayed. For example, a user may select a language at start-up such that subsequent information is presented in a display in accordance with the selected language.

Travelers often experience difficulty using computers outside their native country (despite the ability to select a desired language for the display of information) because input devices such as keyboards, and in particular keyboard key and character layouts, often differ across different countries. For example, a typical keyboard layout in France uses an AZERTY key configuration that is different from that commonly used in the United States, a QWERTY key configuration. The difficulty of using an unfamiliar keyboard arises particularly when travelers use computers located in public places, in business offices, or in hotels where keyboards are generally configured for the local keyboard configuration.

Physical keyboards with raised, movable keys are a worldwide standard input device, and experienced computer users or typists are comfortable using physical keyboards to accurately type information into a computer. Physical keyboards also provide resistance over a short distance while the key is being pressed that softens the impact of a typist's fingers against the keys. Physical keyboards, however, do not offer the flexibility of changing the characters displayed on the keys to match multiple desired keyboard layouts. Accordingly, two different physical keyboards are generally needed to accommodate two different users desiring different keyboard configurations. This is solution is generally not very satisfactory.

Accordingly, it would be desirable to have an input device that allows users to select from and use multiple keyboard configurations, for example, to accommodate various user preferences and the like.

### BRIEF SUMMARY

According to one aspect provided herein, an input device for use with computer systems is described. In one example, an input device comprises a touch-sensitive screen and an overlay positioned over the touch-sensitive screen, the overlay having a plurality of tactile features. The touch-sensitive screen is operable to display one or more images, e.g., of multiple keyboard configurations, to facilitate input to a computer system. The image may be varied to provide a multi-configurable input device. Additionally, the tactile features may include transparent extruded areas, such as ridges, molded key features, indentations, protrusions or the like arranged to provide users with a tactile feel (e.g., for motion and/or location) of varying portions of the underlying displayed image.

The exemplary input device may be incorporated with or operable to communicate with a desktop computer, laptop computer, tablet personal computer, kiosk, mobile device, and the like. Additionally, the touch sensitive screen may be configured to include a portion for displaying an image associated with the overlay and a second portion for displaying additional information such as user information, advertising information, or other visual or touch-sensitive functional items.

In another aspect, a system comprising a touch-sensitive screen and an overlay positioned over the touch-sensitive screen is provided. In one example, the system includes selection logic operable to receive a request for one of a plurality of keyboard configurations or languages, and display logic operable to display an input device image associated with the plurality of keyboard configurations or languages. The input device image is associated with the positions of the tactile features of the overlay.

According to another aspect provided herein a method for displaying one of a plurality of keyboard configurations on a touch-sensitive screen is provided. In one example, the method comprises receiving a request for one of a plurality of languages or keyboard configurations, and displaying an image on a touch-sensitive screen corresponding to a keyboard configuration associated with the language or keyboard configuration, wherein the touch-sensitive screen is operable to provide keyboard input to the computer based on touching of the touch-sensitive screen, and wherein the keyboard includes an overlay comprising tactile features associated therewith.

The present invention and its various embodiments are better understood upon consideration of the detailed description below in conjunction with the accompanying drawings and claims.

### BRIEF DESCRIPTION OF THE DRAWINGS

FIGS. 1A and 1B illustrate exploded front and top views, respectively, of a multi-configurable keyboard comprising a keyboard overlay and a touch-sensitive screen according to one example.

FIG. 1C illustrates an exploded front view of a multi-configurable keyboard comprising a keyboard overlay and a touch-sensitive screen according to another example.

FIG. 2 illustrates a top view of an overlay according to one example.

FIGS. 3A-3E illustrate top, front, rear, right, and left views, respectively, of a multi-configurable keyboard according to one example.

FIGS. 4A-4C illustrate a cross-sectional view of an extruded area of an overlay adjacent a portion of a touch-sensitive screen, and a user pressing the extruded area according to one example.

FIGS. 5A-5D illustrate various systems including a touch-sensitive keyboard according to some examples.

FIGS. 6A and 6B illustrate exploded top and front views of a faceplate, overlay, and touch-sensitive screen, respectively, according to one example.

FIG. 7 illustrates an exploded top view of a faceplate, overlay, and touch-sensitive screen according to another example.

FIGS. 8A and 8B illustrate top and perspective views of exemplary systems including a touch-sensitive screen having a virtual keyboard area and display area according to one example.

FIG. 9 illustrates a top view of an exemplary system including a virtual keyboard area and display area on a touch-sensitive screen according to another example.

### DETAILED DESCRIPTION OF THE INVENTION

Apparatus, systems, and methods are provided for touch-sensitive keyboards capable of displaying multiple keyboard configurations. The following description is presented to allow a person of ordinary skill in the art to make and use various aspects of the inventions. Descriptions of specific materials, techniques, and applications are provided only as examples. Various modifications to the examples described herein will be readily apparent to those skilled in the art, and the general principles defined herein may be applied to other examples and applications without departing from the spirit and scope of the inventions.

According to one example, an input device is provided here where an image of a keyboard (sometimes referred to herein as a “virtual keyboard”) is displayed on a suitable touch-sensitive display device, and where the image of the keyboard, including the configuration of the keyboard and the individual characters, may be changed to represent different keyboard layouts. Typing with a virtual keyboard and touch-sensitive device generally requires touching (or coming in close proximity) to the display surface in an area corresponding to the desired character. Such a touch-sensitive display device, however, generally does not offer the tactile feedback (including either or both of the motion or locational feel of different keys) of conventional physical keyboards. Molded features that assist in locating one's location on the keyboard and/or providing tactile feedback may be a desirable feature of keyboards because such features allow a user to find keys by touch without looking at the keyboard, and such features provide greater assurance that a key has actually been touched such that the typist can continue typing without waiting for each character to appear on the screen. For example, a typist familiar with a conventional physical keyboard will generally type more slowly or make more errors when using a virtual keyboard displayed without physical keys. Furthermore, virtual keyboards do not offer any resistance to soften the impact of a typist's fingers against the surface, which may result in fatigue in the typist's hands, or may require the typist to learn to use a light touch while typing. Virtual keyboards also do not generally allow typists to rest their fingers on the keyboard without causing characters to be entered, as can be done with a physical keyboard.

Accordingly, the exemplary input device further comprises a keyboard overlay having a plurality of tactile features or extruded areas (e.g., raised features, ridges, indentations, or other suitable tactile features) arranged in a pattern similar to keys of a conventional keyboard. The overlay is disposed over the touch-sensitive display device to provide a user a tactile feel similar to conventional keyboard devices. In one example, the extruded areas are at least partially transparent to allow a user to view the underlying touch-sensitive display device, which is operable to display characters corresponding to a selected keyboard configuration. In this fashion, the display device may be operable to display multiple keyboard configurations aligned with the extruded areas. When the touch-sensitive device is touched via a user, e.g., depressing or applying pressure to one or more of the extruded areas, the touch-sensitive device determines a location of the touching and associates the location with a character (either by a microcontroller of the input device or a computer associated with the input device).

In one example, the input device including the touch-sensitive display device and keyboard overlay is used in conjunction with a computer system and display monitor, where the computer system operates with dual display capability (e.g., to display information on both a conventional display device associated with a computer system and the touch-sensitive display device of the input device). In other examples, the touch-sensitive device may be divided into two portions, where a first portion is used to display an image of the keyboard characters associated with the overlay, and a second portion is used to display conventional information. In still other examples, a conventional display may be used in conjunction with a touch-sensitive device divided into at least first and second portions as described, with additional visual and/or functional information displayed in the second portion.

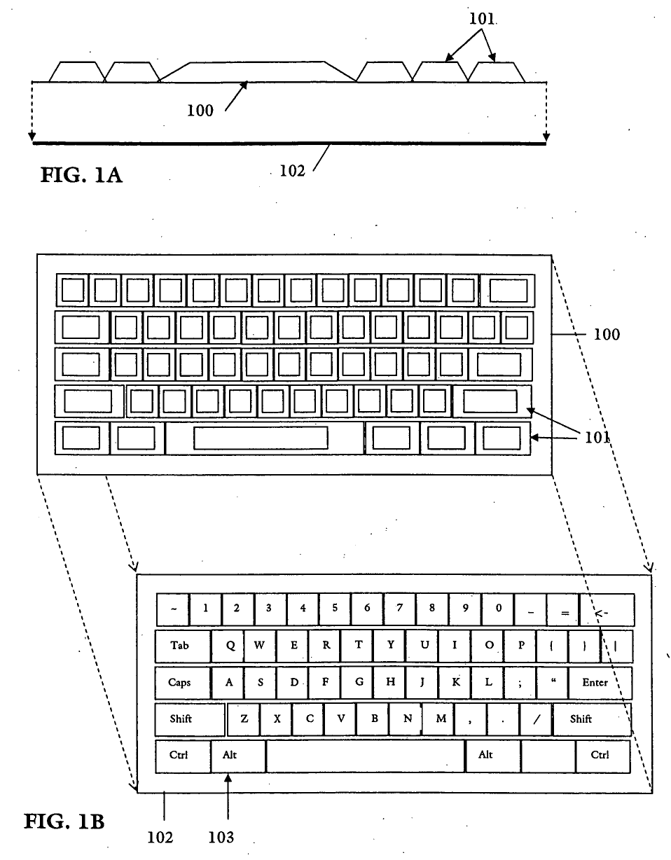

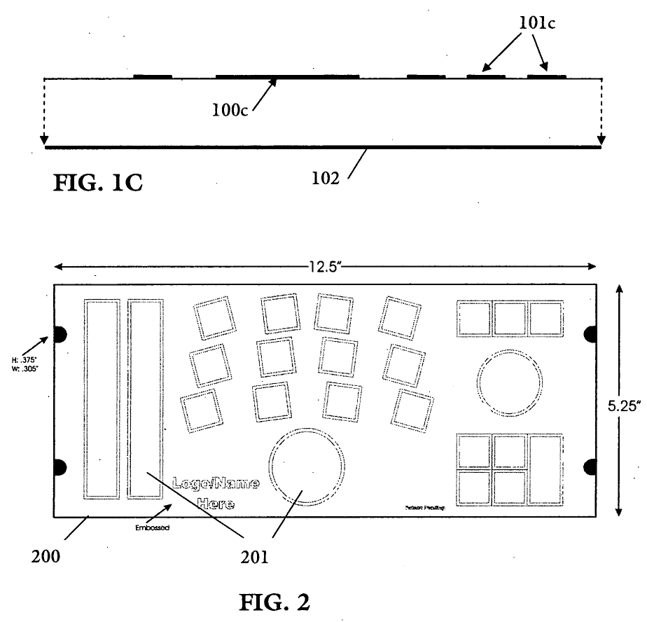

With reference to FIGS. 1A and 1B, an exploded front and top view of an exemplary input device including a keyboard overlay 100 and touch-sensitive screen 102 is illustrated according to one example. Keyboard overlay 100 includes a set of extruded areas 101 arranged to correspond, e.g., to a layout of a conventional keyboard. Touch-sensitive screen 102 is operable to display an image 103 of a keyboard, in this example shown as a conventional QWERTY keyboard configuration. Overlay 100 is disposed over touch-sensitive screen 102 such that extruded areas 101 align with characters or virtual keys of image 103. In one example, the position of each extruded area 101 on overlay 100 corresponds to a position of a character or key of image 103 displayed on touch-sensitive screen 102. In one example, one or more of the extruded areas 101 do not correspond to a key of image 103. In other examples, multiple extruded areas 101 of overlay 100 correspond to a single key of image 103.

In one example, at least a portion of each extruded area 101 is sufficiently transparent to allow the underlying image 103 displayed on touch-sensitive screen 102 to be visible to a user. Each extruded area 101 may be clear or translucent or at least include a portion that is clear or translucent. Overlay 100 and/or extruded areas 101 may include any suitable material to allow a user to view images on touch-sensitive screen 102 therethrough. Further, overlay 100 may include any suitable material to allow a user to depress or apply pressure to an extruded area 101 to register an associated location with touch-sensitive screen 102.

For example, overlay 100 may include a flexible and transparent material such as a plastic or rubber material from which extruded areas 101 may be formed as ridges, protrusions, indentations, or other tactile features arranged similar to standard or typical keyboard keys. In another example, shown generally in FIG. 1C, an overlay 100c includes extruded areas 101c formed as ridges outlining features of the input device. Extruded areas 101c may provide a user with tactile location information of different keys, but not necessarily tactile motion of a conventional keyboard or motion similar to overlay 100 of FIGS. 1A and 1B. Additionally, raised circles or dots similar to Braille systems may be included.

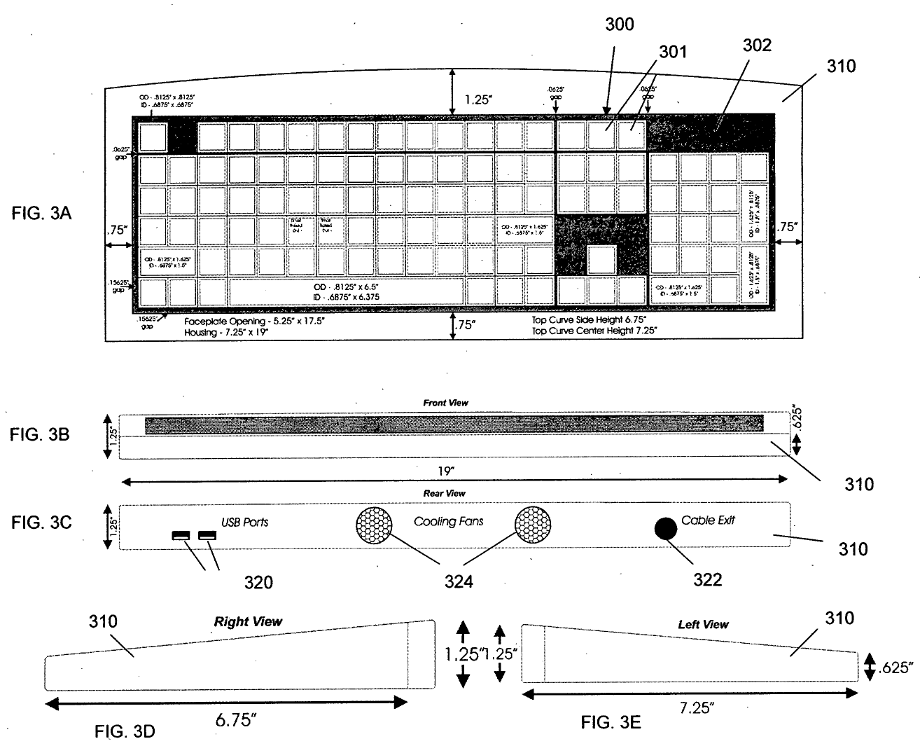

In other examples, extruded areas 101 may include tactile features, which are distinguishable by a user, but dissimilar to standard keyboard keys. For example, an overlay may include features associated with a video editing input device (see e.g., overlay 200 shown in FIG. 2, including extruded areas 201 of varying size and shape), cursor control device, video game controller, or the like. In other examples, overlay 100 and/or extruded areas 101 may include a rigid material, which is sufficiently compliant to transfer touch from a user to the touch-sensitive screen 102 below. Overlay 100 may be manufactured, for example, through injection molding process or other suitable processes.

In another example, overlay 100 may include multiple moving elements corresponding to extruded areas 101. For example, overlay 100 and extruded areas 101 may include rigid portions, wherein individual extruded areas 101 may move relative overlay 101 to touch or cause a touching of the underlying touch-sensitive screen 102. The key features may further be biased (e.g., by a spring or elastic material) similar to a traditional keyboard.

In one example, touch-sensitive screen 102 includes a touch-sensitive capable LCD screen, but any suitable touch-sensitive device is contemplated. For example, any display screen designed or modified to recognize the location of a touch on or in close proximity to its surface may be used. In one example, a touch-sensitive screen may include a grid of sensing lines that determine the location of a touch by matching vertical and horizontal contacts. Another example may include electrically charged sensors around the outer edges of the display screen (or at least around displayed keyboard image 103) to detect the amount of electrical disruption and location of the disruption on the screen. Another example may include infrared light-emitting diodes and sensors around the outer edges of the screen which create a grid that is broken by touch or close proximity. The location of the touch may then be associated with a character of the display and used by a computer system in a conventional manner to process user input.

As is known to those skilled in the art, some types of touch screens are responsive to direct physical contact with an object such as a stylus or finger, while other types of touch screens are responsive to an object in close proximity. Therefore, the use of the term “touch”, “touched”, or “touching” should be understood to not necessarily require direct physical contact between an object and the touch-sensitive screen, but merely require an act sufficient to register a location with the touch-sensitive device.

The touch-sensitive screen 102 may include various sizes. In one example, the touch-sensitive screen and overlay correspond to a typical laptop keyboard configuration and dimensions, e.g., approximately 12-13 inches wide and approximately 4-5 inches deep. In another example, the dimensions may correspond to typical personal computer keyboard dimensions, e.g., approximately 17 inches wide by 6 inches deep, which may allow for a standard 104 key layout, a numerical key pad, and edit keys.

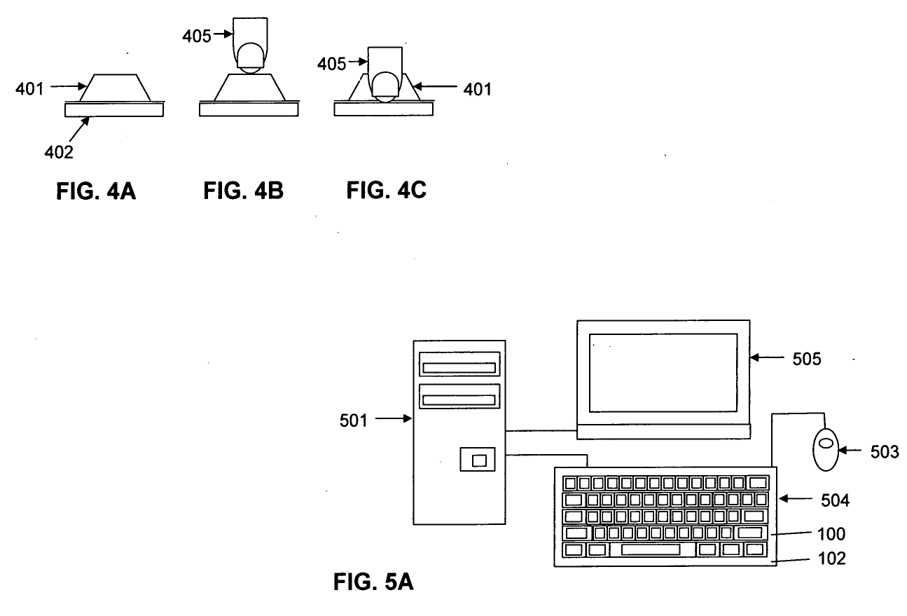

FIGS. 3A-3E illustrate various views of a multi-configurable keyboard according to another example. The present exemplary keyboard is similar to that of FIGS. 1A and 1B, including a touch-sensitive screen 302 and an overlay 300 including multiple extruded areas 301. Additionally, a housing 310 is included, which may serve to house electronics of touch-sensitive screen 302 as well as to secure overlay 300 in place adjacent touch-sensitive screen 302.

Further, as seen clearly in FIG. 3C, housing 310 may include input/output (I/O) ports for various devices, such as USB ports 320 and cable 322, e.g., for power and communication with a computer system. Additionally, housing 310 may include openings for cooling fans 324, which may be desired for the display and processing electronics associated therewith. Additionally, housing 310 may include legs or other members (not shown) for adjusting the height and/or tilt of the device. It will be understood that dimensions of housing 310, overlay 300, and the like are illustrative only and various other sizes and shapes are possible and contemplated.

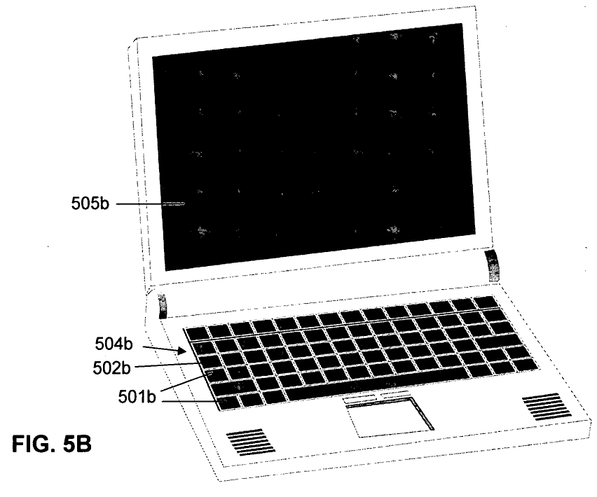

FIGS. 4A-4C illustrate cross-sectional views of an extruded area 401, a portion of a touch-sensitive screen 402, and a finger 405 pressing the extruded area 401 to activate a portion of touch-sensitive screen 402, according to another example. Finger 405 is used for illustrative purposes only; in other examples, a stylus or other member may be used to contact extruded area 401. Extruded area 401 may include a concave ridge which collapses upon pressure and contacts underlying touch-sensitive screen 402. In some examples, the underside of extruded area 401 may include a small protrusion or nub to create a more consistent and/or localized contact with touch-sensitive screen 402 when depressed. Additionally, the underside of extruded area 401 facing screen 402 may include a material optimized for contact with screen 402 (different or similar to a material used for the overlay). In further examples, extruded area 401 may include a solid member (non-concave) which merely transfers pressure through to touch-sensitive screen 402 when touched by a user.

Extruded area 401 and/or touch-sensitive screen 402 may be configured such that if the applied force is below a minimum activation force, touch-sensitive screen 402 will not be touched or activated. If the applied force exceeds the minimum activation force, then touch-sensitive screen 402 will be touched. If touch-sensitive screen 402 is touched, a character corresponding to the key label image 403 displayed under the extruded area 401 will be generated for use as input to, for example, a computer. The activation force may be similar to ranges used with conventional physical keyboards or vary therefrom.

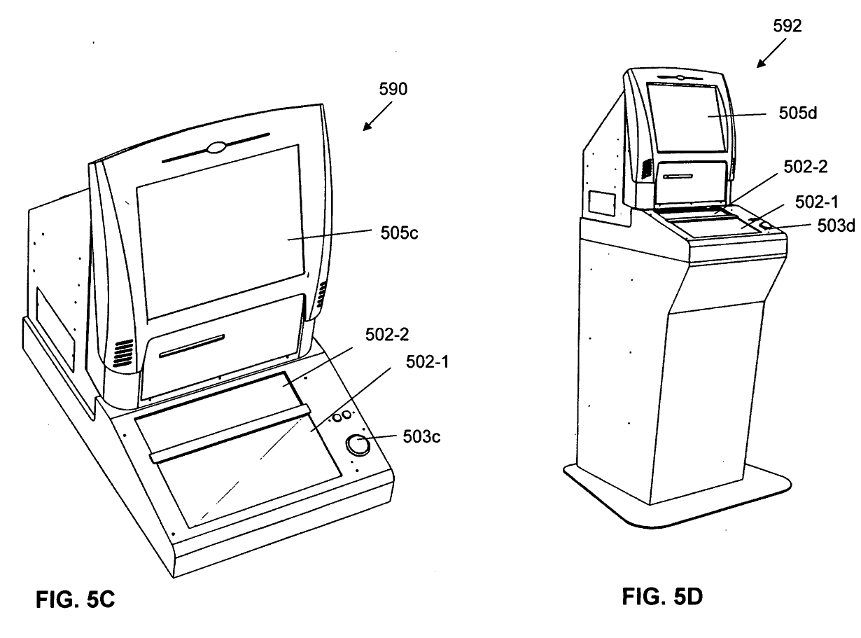

FIG. 5A illustrates a computer system including an input device according to one example. The computer system includes a computer 501, a display screen 505, a mouse 503, and a keyboard input device 504. Keyboard input device 504 includes overlay 100 and touch-sensitive screen 102 as described with respect to FIGS. 1A and 1B. Keyboard input device 504 sends data to computer 501 based on the extruded areas that are pressed sufficiently to activate touch-sensitive screen 102. The data is translated to character input by computer 501 and/or input device 504, where the character input is based on the extruded areas that are activated.

Mouse 503 may be connected to keyboard 504 by, for example, a Universal Serial Bus (USB) connection, in which case keyboard 504 sends input data from mouse 503 to computer 501. In one example, keyboard 504 and mouse 503 may communicate with computer 501 via a wireless connection, e.g. radio or infrared signals, in which case wires connecting the keyboard and mouse to the computer are not required. Additionally, mouse 503 may be connected directly to computer 501, bypassing keyboard 504. Computer 501 may include memory and one or more storage devices such as a hard drive, optical disk drive, and the like.

In one example, keyboard 504 and other computer system components, including, for example, computer 501, display 505, and mouse 503 or the like, may be integrated with or mounted in a kiosk. Additional devices may be associated with the computer, including a trackball, printer, credit card scanner, bill acceptor, and the like.

Software may run on the computer system, e.g. on computer 501, or on keyboard input device 504, or on a combination thereof, or on any other combination of components of the computer system, for selecting/displaying keyboard configurations and processing user input. The software may include keyboard configuration software that allows a user to select a language. In other examples, keyboard configuration selection logic may be carried out via firmware and/or hardware alone or in combination with suitable software.

The user may use mouse 503 or keyboard 504 to select a language based on information displayed on touch screen 102 or on display 505. For example, a list of languages may be displayed on display 505, and the user may select a language from the list using mouse 503. As another example, the user may select the language by pressing keys on keyboard 504 based on information such as language names or characters displayed on touch screen 102. In another example, language selection may occur when a user logs in. In yet another example, language selection may occur at any time in response to a user's request to change the language. As yet another example, language selection facilities of the operating system may be used to select the language. In a further example, language selection may occur when the computer starts up.

In one example, multi-lingual features of the operating system, such as Microsoft Windows™, Macintosh™ Mac OS™, Linux™, or the like and onscreen keyboard software may be used such that the computer displays a keyboard image associated with a language selected when the computer starts up. In other examples, the software may select the language based on other types of input, such as voice input. In still other examples, the software may select the language based on a command from a server, or based on geographical location information, or based on a device such as a switch or button associated with one of the computer components. For example, a multi-position switch may be associated with keyboard 504, where each position on the switch corresponds to a language, and the user selects a language by setting the switch to the position corresponding to that language.

Commercially available software which may be used in conjunction with certain examples for providing on-screen keyboard software is available, for example, through Madentec Limited of Edmonton, Alberta, Canada (www.madentec.com) or Innovation Management Group, Inc.(IMG) of Chatsworth, Calif. (www.myttouch.com), both of which have made available software programs that allow a mouse-click to synthesize a keystroke in an on-screen display.

When a language has been selected, a keyboard layout corresponding to that language may be displayed on touch screen 102. Information displayed by the computer on touch screen 102 or on display 505 may be displayed in a format based on the selected language, or in a format based on a locale that may be selected based on or separately from the language. For example, text displayed by the computer may be displayed in the selected language. Different geographical and cultural regions or locales have different locale-specific standards for presentation of information, such as date formats, currency formats, numeric formats, and the like. A computer's operating system may be configured to use a specific locale. In some examples, the locale may be selected based on the selected language. In other examples, the locale may be set to a default value. However, some languages are used in more than one locale, such as English in the locales of the United States and the United Kingdom, so it may be desired to allow selection of the locale separately from selection of the language. It is contemplated that the locale may be selected based on the selected language, or based on any of the techniques previously described for selecting the language, including keyboard input, mouse input, and so on.

The two configuration options described above, the language and the locale may be stored, along with any other desired configuration information, for subsequent use, so that the information need not be selected every time a user logs in or every time the computer is restarted. The configuration options may be stored on a device associated with the computer system, such as a hard disk, or on a server with which the computer system communicates. Software may store the configuration when the configuration is selected, and may retrieve the configuration when the configuration is required, e.g. when the computer is restarted or when a user logs in.

The software running on the computer, including, for example, the operating system and applications, may be localized to a locale such as a geographic region. Localization of the software to a locale may include configuring the software to display information in a format based on the locale. The locale may be selected by software based on the selected language.

A keyboard layout may be selected based on information in addition to a selected language, or based on information other than a selected language. For example, a locale may be selected by a user in addition to the language, in which case the keyboard layout corresponding to the selected region and language may be displayed on touch screen 102. As another example, a region may be selected instead of the language, in which case the keyboard layout corresponding to the selected region may be displayed on touch screen 102.

FIGS. 5B-5D illustrate various other exemplary systems including an input device as described herein. In particular, FIG. 5B illustrates an exemplary laptop computer including a keyboard 504b comprising a touch-sensitive display screen 502b and overlay including a plurality of extruded areas 501b. The laptop further includes a conventional display 505b associated with keyboard 504b. In addition to the laptop shown in FIG. 5B, which may include wireless capability, other remote or handheld devices, such as mobile phones, personal digital assistants (PDAs), GPS devices, navigation systems, and the like may also include an input device as described herein.

FIGS. 5C and 5D illustrate exemplary table-top and stand alone kiosks 590 and 592, each including a touch-sensitive keyboard as described herein. In these examples, kiosk 590 and 592 include a touch-sensitive screen divided into two portions, a first portion 502-1 for displaying the virtual keyboard corresponding to an overlay (not shown) and a second portion 502-2 for displaying additional information, such as advertising information (described in greater detail below), hot keys (e.g., for changing applications), stock ticker, Instant Messenger interface, sports score ticker, news crawlers, or the like. The examples may further include an input device such as a roller ball 503c and 503d or the like.

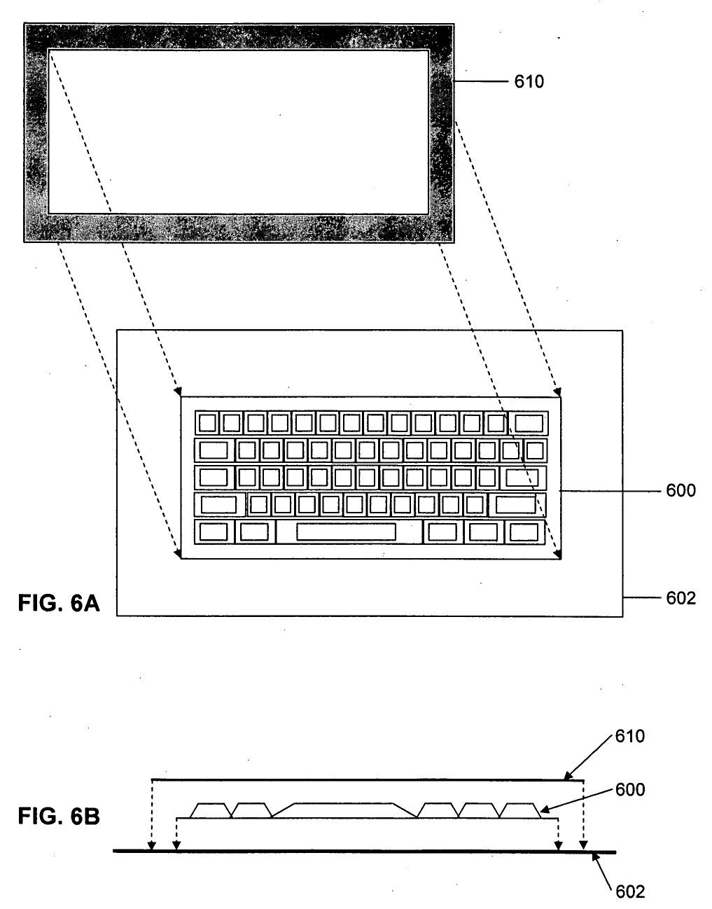

FIG. 6A illustrates an exploded top view of a faceplate 610, keyboard overlay 600, and touch-sensitive screen 602, and FIG. 6B illustrates an exploded front view of faceplate 610 positioned over an overlay 600 according to other embodiments of the invention. In this example, faceplate 610 is used to secure overlay 600 with respect to touch-sensitive screen 602. For example, faceplate may be snapped, screwed, latched, glued, or otherwise removably or permanently fixed with respect to screen 602. It may be desired to replace overlay 600 over time, e.g., the life of overlay 600 may be significantly less than that of screen 602, and a system where overlay 600 may be easily replaced is by quickly removing faceplate 610 may be desired. Additionally, it may be desired to swap overlay 600 with another configuration, such as overlay 200 of FIG. 2. In other examples, faceplate may include multiple members and need not extend entirely around screen 602 or may be formed integral with a housing for the input device.

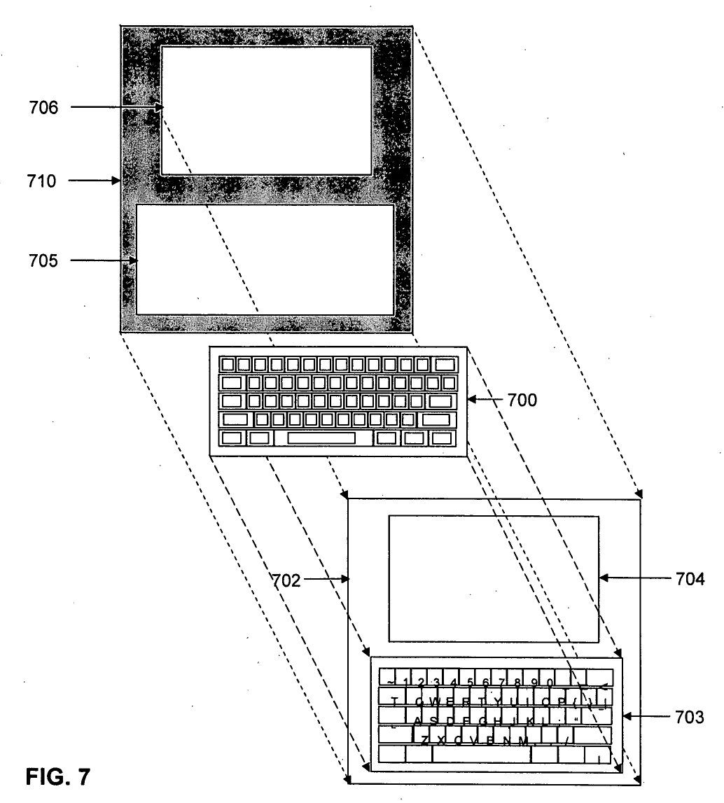

FIG. 7 illustrates an exploded view of an input device including a faceplate 710 positioned over a touch-sensitive screen 702 and an overlay 700 according to other embodiments of the invention. In this example, a first portion 703 of screen 702 is used for displaying an image, e.g. of a keyboard, under overlay 700 similar to that described with reference to FIGS. 1-4, and a second portion 704 of screen 702 is used for displaying information. In this example, an optional faceplate 710 includes a lower aperture 705 corresponding to first portion 703 of screen 702 and an upper aperture 706 corresponding to second portion 704 of screen 702. In other examples, face plate 710 may include a single aperture. When faceplate 710 is positioned on top of touch screen 702, the image displayed on first portion 703 is visible to a user through lower aperture 705, and the information displayed on second portion 704 is visible to a user through upper aperture 706. The information in second portion 704 may be visual information displayed for the computer or additional visual information displayed in addition to a separate monitor. For example, the second portion 704 may display advertising information in addition to a conventional display monitor for user information.

Suitable logic or software may be used to display the keyboard and the information on the same screen 702, e.g., in first and second portion 703 and 704 as described. For example, software may retrieve all or part of the information from a server, and the software may store all or part of the information on the computer associated with the screen (e.g., on a hard drive on computer 501 of FIG. 5). The additional information may include advertising items, links, layout, and so on. Screen 702 may be of any standard touch screen size, such as 10″, 12″, 13″, 15″, or 17″. In one example, a 15″ screen may have an 11″ by 5″ first area and an 11″ by 3″ second area. The aperture 706 may further include a transparent insert or portion allowing a user to see underlying second portion 704 of screen 702.

The keyboard image may be “docked” in place corresponding to the first display portion 703 by suitable software (e.g., the keyboard image is locked in place on the screen and remains in the foreground during operation). Additionally, other touch-sensitive functions, systems, and methods known in the art may be carried out in second portion 704. For examples, hot keys operable to launch program applications, audio/video players, or the like may be included in this area.

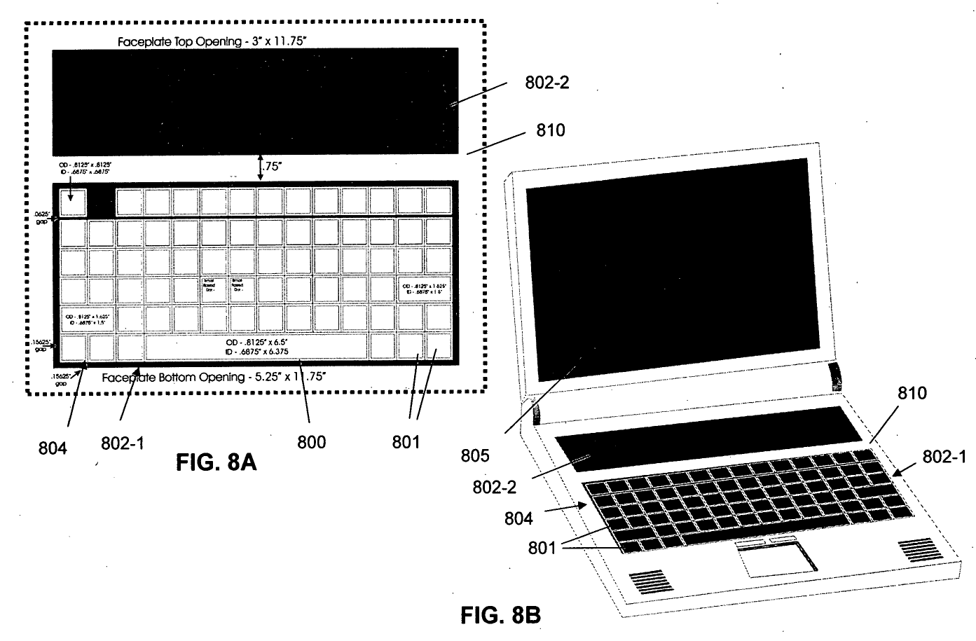

FIGS. 8A and 8B illustrate top and perspective views of exemplary keyboard 804 including a virtual keyboard area 802-1 and display area 802-2 on a touch-sensitive screen according to another example. In particular, a faceplate 810 includes openings to define display area 802-1 for the virtual keyboard corresponding to overlay 800 and extruded areas 801 as well as display area 802-2, which may display and/or include various other features and functions as described herein. Keyboard 804 is shown with a laptop computer and laptop display 805, but keyboard 804 may also be used with a desktop computer, tablet personal computer (e.g., without display 805), kiosk, remote/handheld device, or the like.

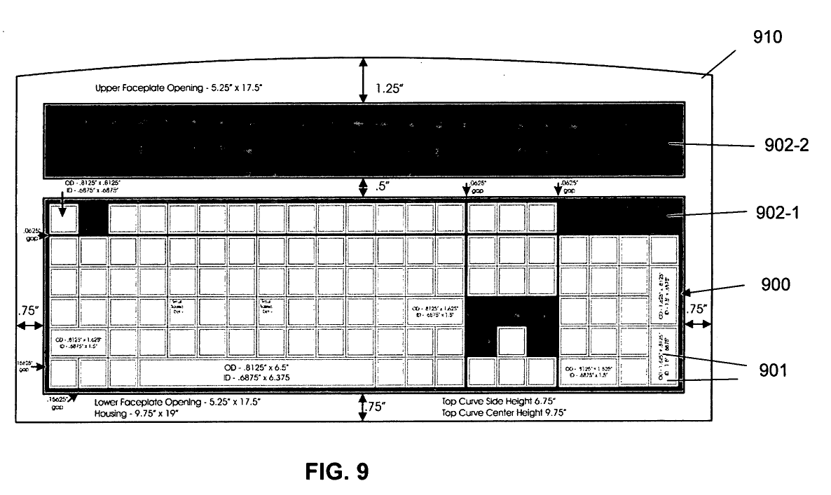

FIG. 9 illustrates a top view of an exemplary system including a virtual keyboard area 902-1 and display area 902-2 associated with a touch-sensitive screen according to another example. The example is shown for variation in the keyboard size and key configuration. Additionally, overlay 900 and extruded areas 901 may vary and be swappable with faceplate or housing 910, e.g., to include an overlay such as that shown in FIG. 2 or the like.

The above description is exemplary only and it will be apparent to those of ordinary skill in the art that numerous modifications and variations are possible. For example, various exemplary methods and systems described herein may be used alone or in combination with various other computer and computer peripheral systems and methods. Additionally, particular examples have been discussed and how these examples are thought to address certain disadvantages in related art. This discussion is not meant, however, to restrict the various examples to methods and/or systems that actually address or solve the disadvantages.

What is claimed is:

1. An input device operable with a computer system, the input device comprising:
a touch-sensitive screen; and
an overlay positioned over the touch-sensitive screen, the overlay having a plurality of tactile features.

2. The input device of claim 1, wherein each of the plurality of tactile features includes an extruded area.

3. The input device of claim 2, wherein at least a portion of each of the extruded areas is operable to touch the screen in response to a force applied to the extruded area toward the touch-sensitive screen.

4. The input device of claim 2, wherein the extruded areas include one of a protrusions, ridge, or indentation.

5. The input device of claim 1, wherein the touch-sensitive screen is operable to generate a coordinate location value in response to touching of the screen.

6. The input device of claim 1, wherein the touch-sensitive screen is operable to display at least two different images associated with the position of the plurality of tactile areas.

7. The input device of claim 1, wherein the touch-sensitive screen is operable to display at least two different images associated with two different keyboard configurations.

8. The input device of claim 1, wherein the touch-sensitive screen includes a first portion associated with the overlay and plurality of tactile features, and a second area associated with a display area.

9. The input device of claim 1, wherein the overlay includes a flexible transparent material.

10. The input device of claim 1, wherein the touch-sensitive screen and overlay are included with a housing.

11. The input device of claim 1, further comprising a faceplate securing the overlay over a first portion of the touch-sensitive screen.

12. The input device of claim 11, wherein the faceplate comprises an aperture allowing access to the tactile features through the aperture.

13. The input device of claim 12, wherein the faceplate further includes a second aperture corresponding to a second portion of the touch-sensitive screen.

14. A computer system, comprising:
a computer; and
the input device of claim 1, wherein the input device is operable to provide input to the computer.

15. The computer system of claim 14, further comprising a display device.

16. The computer system of claim 15, wherein the computer, display device, and input device are associated with a common housing.

17. The computer system of claim 15, wherein the computer, display device, and input device are associated with a kiosk.

18. The computer system of claim 15, wherein the computer, display device, and input device are associated with a laptop computer.

19. The computer system of claim 14, wherein the computer includes a remote device.

20. A system comprising:
a touch-sensitive screen;
an overlay positioned over the touch-sensitive screen and having a plurality of tactile features;
selection logic operable to receive a request for one of a plurality of input configurations, and
display logic operable to display an input device image associated with the plurality of input configurations, wherein the input device image is based upon the positions of the tactile features of the overlay

21. The system of claim 20, wherein the selection logic includes language selection logic operable to receive a request for one of a plurality of languages.

22. The system of claim 20, wherein the selection logic includes keyboard configuration selection logic operable to receive a request for one of a plurality of keyboard configurations.

23. The system of claim 20, wherein each of the plurality of tactile features includes an extruded area.

24. A method for displaying one of a plurality of keyboard configurations on a touch-sensitive screen, the method comprising the acts of:
receiving a request for one of a plurality of keyboard configurations; and
displaying an image on a touch-sensitive screen corresponding to the keyboard configuration, wherein the touch-sensitive screen is operable to provide keyboard input to a computer based on touching of the touch-sensitive screen, and wherein the keyboard includes an overlay comprising tactile features associated therewith.

25. The method of claim 24, wherein the plurality of keyboard configurations are associated with a plurality of languages, and the request for one of a plurality of keyboard configuration comprises a request for one of the plurality of languages.

26. The method of claim 24, further including displaying a list of users on a screen, wherein each user is associated with one of the plurality of keyboard configurations and selection of a user initiates a request for the one of the plurality of keyboard configurations.
